(19) United States
(12) Patent Application Publication
(10) Pub. No.: US 2023/0216872 A1
(43) Pub. Date: Jul. 6, 2023

(54) SAMPLE DATA GENERATION APPARATUS, SAMPLE DATA GENERATION METHOD, AND COMPUTER READABLE RECORDING MEDIUM

(71) Applicant: NEC Corporation, Minato-ku, Tokyo (JP)

(72) Inventor: Satoshi IKEDA, Tokyo (JP)

(73) Assignee: NEC Corporation, Minato-ku, Tokyo (JP)

(21) Appl. No.: 17/928,009

(22) PCT Filed: May 29, 2020
(86) PCT No.: PCT/JP2020/021325

§ 371 Date: Nov. 28, 2022

(51) Int. Cl. H04L 9/40; H04L 43/04

(52) U.S. Cl. CPC H04L 63/1425; H04L 43/04

(57) ABSTRACT

A information processing apparatus 10, includes: an extraction unit 11 configured to obtain communication history information classified based on a communication source, a communication destination, and a communication date/time; and a generation unit 12 configured to generate sample data to be used in metric learning by adding a label to data generated by associating the classified communication history information, the communication source, the communication destination, and the communication date/time.

### TECHNICAL FIELD

The invention relates to a sample data generation apparatus and a sample data generation method that extract sample data to be used in metric learning, and further relates to a computer readable recording medium that includes a program recorded thereon, the program being intended to realize the apparatus and method.

### BACKGROUND ART

Metric learning is known as a method of learning a metric (e.g., a distance or a similarity degree) between pieces of data (patent document 1). Metric learning is learning that brings pieces of data with close meanings close together, while placing pieces of data with distant meanings far from each other.

### LIST OF RELATED ART DOCUMENTS

### Patent Document

Patent document 1: Japanese Patent Laid-Open Publication No. 2019-509551

### SUMMARY OF INVENTION

### Technical Problems

However, in metric learning, it is necessary to provide, in learning, pairs of close data (positive example pairs) and pairs of distant data (negative example pairs) as sample data. In general, pairs of close data and pairs of distant data need to be provided manually. In view of this, there is a demand for efficient generation of sample data to be used in metric learning.

As one aspect, an example object is to provide a sample data generation apparatus, a sample data generation method, and a computer readable recording medium that efficiently generate sample data to be used in metric learning.

### Solution to the Problems

In order to achieve the example object described above, a sample data generation apparatus according to an example aspect of the invention includes:

an extraction unit configured to obtain communication history information classified based on a communication source, a communication destination, and a communication date/time; and

a generation unit configured to generate sample data to be used in metric learning by adding a label to data generated by associating the classified communication history information, the communication source, the communication destination, and the communication date/time.

Also, in order to achieve the example object described above, a sample data generation method according to an example aspect of the invention includes:

an extraction step of obtaining communication history information classified based on a communication source, a communication destination, and a communication date/time; and

a generation step of generating sample data to be used in metric learning by adding a label to data generated by associating the classified communication history information, the communication source, the communication destination, and the communication date/time.

Also, in order to achieve the example object described above, a computer-readable recording medium according to an example aspect of the invention includes a program recorded on the computer-readable recording medium, the program including instructions that cause the computer to carry out:

an extraction step of classifying communication history information classified based on a communication source, a communication destination, and a communication date/time; and

a generation step of generating sample data to be used in metric learning by adding a label to data generated by associating the classified communication history information, the communication source, the communication destination, and the communication date/time.

In order to achieve the example object described above, a metric learning apparatus according to an example aspect of the invention includes:

an extraction unit configured to obtain communication history information classified based on a communication source, a communication destination, and a communication date/time;

a generation unit configured to generate sample data to be used in metric learning by adding a label to data generated by associating the classified communication history information, the communication source, the communication destination, and the communication date/time; and

a learning unit configured to learn a conversion model with use of the sample data by way of metric learning.

Also, in order to achieve the example object described above, a metric learning method according to an example aspect of the invention includes:

an extraction step of obtaining communication history information classified based on a communication source, a communication destination, and a communication date/time;

a generation step of generating sample data to be used in metric learning by adding a label to data generated by associating the classified communication history information, the communication source, the communication destination, and the communication date/time; and

a learning step of learning a conversion model with use of the sample data by way of metric learning.

Also, in order to achieve the example object described above, a computer-readable recording medium according to an example aspect of the invention includes a program recorded on the computer-readable recording medium, the program including instructions that cause the computer to carry out:

an extraction step of obtaining communication history information classified based on a communication source, a communication destination, and a communication date/time;

a generation step of generating sample data to be used in metric learning by adding a label to data generated by associating the classified communication history information, the communication source, the communication destination, and the communication date/time; and

a learning step of learning a conversion model with use of the sample data by way of metric learning.

Also, in order to achieve the example object described above, a search apparatus according to an example aspect of the invention includes:

an extraction unit configured to obtain communication history information classified based on a communication source, a communication destination, and a communication date/time, a extracting feature vector indicating feature of communication with use of the classified communication history information, and generating data by associating the communication source, the communication destination, the communication date/time, and the feature vector;

a generation unit configured to extract a pair of data that acts as a positive example or a negative example based on the communication source and the communication destination, and generating sample data to be used in metric learning by adding a label indicating a positive example or a negative example to the extracted pair;

a learning unit configured to learn, with use of the sample data, a conversion model that convers feature vector into low-dimensional vector; and

a search unit configured to calculate a distance between a low-dimensional vector obtained by converting a feature vector of a search target with use of the conversion model and a low-dimensional vector obtained by converting feature vector of the data with use of the conversion model, and searching for data with the calculated distance equal to or shorter than a preset distance.

Also, in order to achieve the example object described above, a search method according to an example aspect of the invention includes:

an extraction step of obtaining communication history information classified based on a communication source, a communication destination, and a communication date/time, extracting feature vector indicating feature of communication with use of the classified communication history information, and generating data by associating the communication source, the communication destination, the communication date/time, and the feature vector;

a generation step of extracting a pair of data that acts as a positive example or a negative example based on the communication source and the communication destination therein, and generating sample data to be used in metric learning by adding a label indicating a positive example or a negative example to the extracted pair;

a learning step of learning, with use of the sample data, a conversion model that convers feature vector into low-dimensional vector; and

a search step of calculating a distance between a low-dimensional vector obtained by converting a feature vector of a search target with use of the conversion model and low-dimensional vectors obtained by converting feature vectors of the data with use of the conversion model, and searching for data with the calculated distance equal to or shorter than a preset distance.

Also, in order to achieve the example object described above, a computer-readable recording medium according to an example aspect of the invention includes a program recorded on the computer-readable recording medium, the program including instructions that cause the computer to carry out:

an extraction step obtaining communication history information classified based on a communication source, a communication destination, and a communication date/time, extracting feature vector indicating feature of communication with use of the classified communication history information, and generating data by associating the communication source, the communication destination, the communication date/time, and the feature vector;

a generation step of extracting a pair of data that acts as a positive example or a negative example based on the communication source and the communication destination therein, and generating sample data to be used in metric learning by adding a label indicating a positive example or a negative example to the extracted pair;

a learning step of learning, with use of the sample data, a conversion model that convers feature vector into low-dimensional vector; and

a search step of calculating a distance between a low-dimensional vector obtained by converting a feature vector of a search target with use of the conversion model and low-dimensional vector obtained by converting feature vector of the data with use of the conversion model, and searching for data with the calculated distance equal to or shorter than a preset distance.

### Advantageous Effects of the Invention

As one aspect, it is possible to efficiently generate sample data to be used in metric learning.

### BRIEF DESCRIPTION OF THE DRAWINGS

FIG. 1 is a diagram for describing one example of a sample data generation apparatus.

FIG. 2 is a diagram for describing one example of a system.

FIG. 3 is a diagram for describing one example of a system that includes an information processing apparatus.

FIG. 4 is a diagram for describing examples of communication history information pieces.

FIG. 5 is a diagram for describing one example of data that includes feature vectors.

FIG. 6 is a diagram for describing one example of metric learning.

FIG. 7 is a diagram for describing one example of the operations of the sample data generation apparatus.

FIG. 8 is a diagram for describing one example of the operations of a metric learning apparatus.

FIG. 9 is a diagram for describing one example of the operations of a search apparatus.

FIG. 10 is a diagram for describing one example of an information processing apparatus.

FIG. 11 is a diagram for describing one example of training data.

FIG. 12 is a diagram for describing one example of the operations of the metric learning apparatus.

FIG. 13 is a block diagram showing an example of a computer that realizes the information processing apparatus according to first and second example embodiments.

### EXAMPLE EMBODIMENT

First, in order to facilitate the understanding of example embodiments to be described below, a description is given of a background that assumes an implementation in security measures. Threat hunting is known as a method of security measures that detects a threat that has already infiltrated a system of an organization.

As one method of threat hunting, there is a method of detecting such threats as malware, viruses, and attackers with use of threat information provided by an outside agency. However, it cannot be said that the completeness of threat information is always high.

For example, a worker engaged in security measures detects a threat by searching through logs that have been generated by the system of the organization with use of IoC (Indicator of Compromise) and the like as threat information.

However, in a case where IoC is a domain, an IP address associated with the domain, or the like, an attacker can easily change the domain, the IP address associated with the domain, or the like, and thus a threat cannot be detected if they are changed. Also, in a case where a C&C (Command and Control) server is changed in accordance with an organization to be attacked for the purpose of avoiding a detection, a threat cannot be detected even if the search is performed using IoC related to attacks made on other organizations.

Furthermore, as threat information related to attacks, such as IoC, is limited in number, even if a threat has been detected by searching through logs with use of IoC, the worker engaged in security measures needs to confirm whether there are threats similar to the detected threat.

In order to confirm whether there are similar threats, the worker engaged in security measures needs to analyze the features of detected threats and manually generate search conditions. In addition, in a case where excessive detections occur frequently under the generated search conditions, the worker engaged in security measures needs to revise the search conditions.

In view of the above, the inventor has discovered the problems mentioned above, and has also come to derive a means to solve such problems. That is to say, the inventor has come to derive a means that can search for similar threats with use of the features of logs without a worker engaged in security measures manually generating search conditions.

Furthermore, the inventor has come to derive a means that can reduce tasks of a worker engaged in security measures also in relation to the confirmation of similar threats. In addition, the inventor has come to derive a means that can automatically extract similar threats as if they were extracted by a worker engaged in security measures (with human senses).

Below, example embodiments will be described with reference to the drawings. Note that the elements that have the same function or corresponding functions are given the same reference sign in the drawings to be described below, and a redundant description thereof may be omitted.

### First Example Embodiment

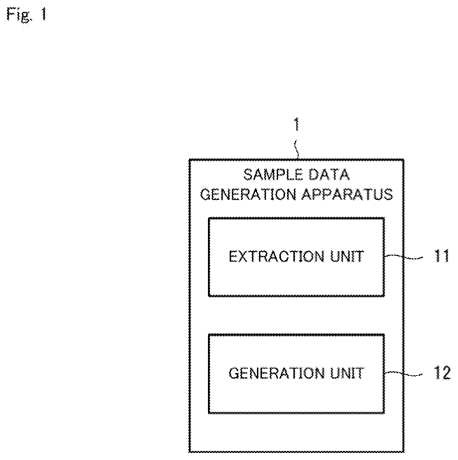

A configuration of a sample data generation apparatus according to a first example embodiment will be described using FIG. 1. FIG. 1 is a diagram for describing one example of the sample data generation apparatus.

[Apparatus Configuration]

A sample data generation apparatus 1 shown in FIG. 1 is an apparatus that efficiently extracts sample data to be used in metric learning. Also, as shown in FIG. 1, the sample data generation apparatus 1 includes an extraction unit 11 and a generation unit 12.

The extraction unit 11 obtains communication history information pieces that have been classified based on a communication source, a communication destination, and a communication date/time. Note that the extraction unit 11 may group communication history information pieces based on the communication source, the communication destination, and the communication date/time. The generation unit 12 generates sample data to be used in metric learning by adding a label to data that has been generated by associating each of the classified communication history information, the communication source, the communication destination, and the communication date/time.

As described above, in the first example embodiment, sample data to be used in metric learning can be generated efficiently. Note that while metric learning generally uses classification information (classification labels) that has been generated in advance as training data of a classification problem, the first example embodiment does not use such classification information but uses communication history information pieces that have been classified based on the communication source, the communication destination, and the communication date/time.

[System Configuration]

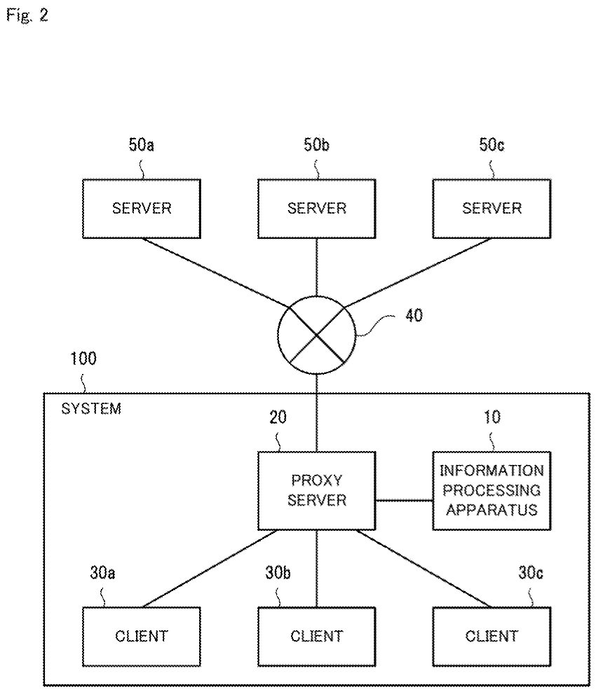

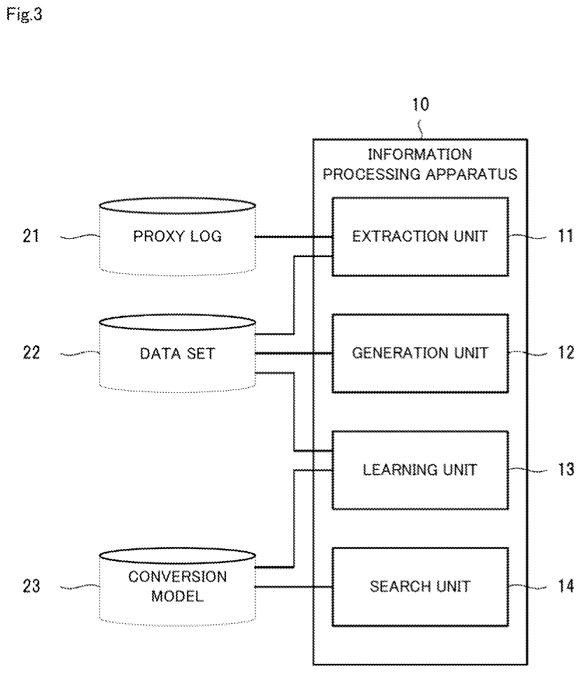

A configuration of a system 100 that includes an information processing apparatus 10 according to the first example embodiment will be specifically described using FIG. 2. FIG. 2 is a diagram for describing one example of a system. Also, a configuration of the information processing apparatus 10 according to the first example embodiment will be specifically described using FIG. 3. FIG. 3 is a diagram for describing one example of a system that includes an information processing apparatus.

A description is now given of the system 100.

In the example of FIG. 2, the system 100 includes the information processing apparatus 10, a proxy server 20, and clients 30. Note that the configuration of the system according to the first example embodiment is not limited to the configuration of the system 100 shown in FIG. 2.

The information processing apparatus 10 is, for example, a server computer, a personal computer, or the like provided with one or both of a CPU (Central Processing Unit) and a programmable device, such as an FPGA (Field-Programmable Gate Array). Also, as shown in FIG. 3, the information processing apparatus 10 includes an extraction unit 11, a generation unit 12, a learning unit 13, and a search unit 14. Furthermore, the information processing apparatus 10 includes internal or external storage units 21, 22, and 23.

In a case where the information processing apparatus 10 is used as a sample data generation apparatus, a configuration that includes the extraction unit 11 and the generation unit 12, as shown in FIG. 1, is used. Also, in a case where the information processing apparatus 10 is used as a metric learning apparatus, a configuration that includes the extraction unit 11, the generation unit 12, and the learning unit 13 is used. Furthermore, in a case where the information processing apparatus 10 is used as a search apparatus, a configuration that includes the extraction unit 11, the generation unit 12, the learning unit 13, and the search unit 14 is used.

The proxy server 20 transmits a request obtained from a client 30 to a server 50 designated by the obtained request via a network 40. The request is, for example, a request for HTTP communication between the client 30 and the server 50. Note that the request is not limited to being for HTTP communication.

The proxy server 20 stores an access log (communication history information), which is information related at least to the request, into the storage unit 21. In the example of FIG. 3, proxy logs are stored in the storage unit 21.

The clients 30 (30a, 30b, and 30c) access servers 50 that are connected to the network 40 via the proxy server 20. The network 40 is, for example, a network such as the Internet. The servers 50 (50a, 50b, and 50c) are, for example, HTTP (Hypertext Transfer Protocol) servers and the like.

A description is now given of the information processing apparatus 10.

The extraction unit 11 generates data by extracting feature vectors that indicate the features of communication with use of classified communication history information pieces, and associating the communication source, the communication destination, the communication date/time, and the corresponding feature vector with one another.

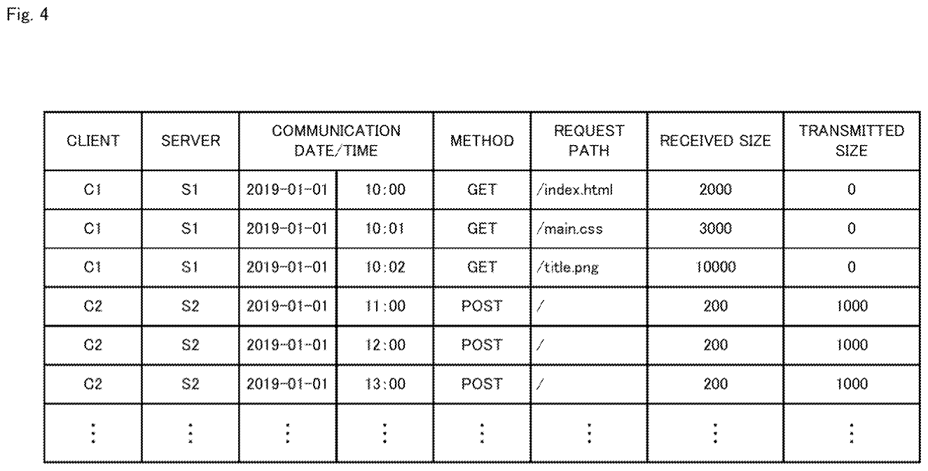

Communication history information is information in which at least the communication source, the communication destination, and the communication date/time are associated with one another. FIG. 4 is a diagram for describing examples of communication history information pieces.

In the example of FIG. 4, communication history information represents a proxy log. Under “client” of a proxy log, information that identifies a client 30, such as “C1” and “C2”, is stored. Under “server”, information that identifies a server 50, such as “S1” and “S2”, is stored. Under “communication date/time”, information that indicates year, month, date, and time is stored.

Also, stored under “method” is “GET”, “POST”, or the like that indicates a method. Stored under “request path” is “/index.html”, “/main.css”, “/title.png”, “/”, or the like that indicates a request path. Stored under “received size” is “2000”, “3000”, “10000”, “200”, or the like that indicates the size of received data. Stored under “transmitted size” is “0”, “1000”, or the like that indicates the size of transmitted data.

Furthermore, a proxy log stores, for example, a character string of a practical user agent that is included in a request transmitted by a client 30.

Specifically, first, the extraction unit 11 classifies communication history information pieces based on information that identifies a client 30 (communication source), information that identifies a server 50 (communication destination), and a communication date/time on which the client 30 and the server 50 communicated with each other, which are included in the communication history information pieces stored in the storage unit 21.

For example, the extraction unit 11 classifies communication history information together with communication history information pieces that include the same client 30, server 50, and preset predetermined time period. The predetermined time period means, for example, the same year, month, and date, the same year, month, date, and time slot, or a time period encompassing years, months, or dates that are close to one another.

Note that classification of communication history information pieces need not necessarily be performed by the extraction unit 11; a classification unit may be provided separately from the extraction unit 11, and the classification unit may classify communication history information pieces.

Subsequently, the extraction unit 11 extracts feature vectors indicating the features of communication with use of classified communication history information pieces.

Subsequently, the extraction unit 11 generates data by associating information that identifies a client 30, information that identifies a server 50, information that indicates a predetermined time period, and an extracted feature vector with one another, and stores the data into the storage unit 22. In the example of FIG. 3, the data is stored in a data set in the storage unit 22.

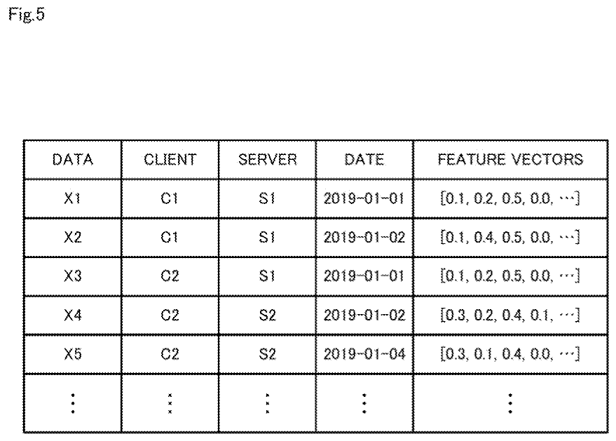

FIG. 5 is a diagram for describing one example of data that includes feature vectors. In the example of data of FIG. 5, information that identifies a client 30, such as “C1” and “C2”, is stored under “client”. Under “server”, information that identifies a server 50, such as “S1” and “S2”, is stored. Under “date”, information that indicates year, month, and date is stored. Under “feature vectors”, information that indicates feature vectors is stored.

Feature vectors include the following elements. They include, for example, statistics of the transmitted size and the received size (e.g., the minimum values, maximum values, average values, variances, total values, and so forth), a statistic of request path lengths (the minimum value, maximum value, average value, variance, and so forth), the frequencies of extensions of request paths (the percentage of a request for each extension, such as html, css, and png), the frequencies of methods (the percentages of requests, such as GET, POST, and HEAD), the distribution of access times (the percentages of requests per unit time (e.g., one hour)), the number of requests, and the like. Note that in a case where a proxy log includes header information, features related to such header information may be extracted. The method of feature extraction is not limited to these, and it is also permissible to use a common method that is used in conversion into a feature vector in machine learning.

The generation unit 12 extracts a pair of data that acts as a positive example or a negative example based on the communication sources and the communication destinations of the data, and generates sample data to be used in metric learning by adding a label indicating a positive example or a negative example to the extracted pair.

Specifically, first, the generation unit 12 extracts a pair of data that include the same client 30 and server 50 (a positive example pair) with reference to data in the storage unit 22 (data set). Note that it is permissible to perform the extraction with use of sampled data, without using all data. Subsequently, the generation unit 12 generates sample data by adding a label indicating a positive example to the extracted pair.

In the example of FIG. 5, the pair of data X1 and X2 (X1, X2) and the pair of data X4 and X5 (X4, X5) act as positive example pairs.

Also, the generation unit 12 extracts a pair of data that include different clients 30 and servers 50 (a negative example pair) with reference to data in the storage unit 22 (data set). Note that it is permissible to perform the extraction with use of sampled data, without using all data.

Subsequently, the generation unit 12 generates sample data by adding a label indicating a negative example to the extracted pair of data.

In the example of FIG. 5, the pair of data X1 and X4 (X1, X4), the pair of data X1 and X5 (X1, X5), the pair of data X2 and X4 (X2, X4), and the pair of data X2 and X5 (X2, X5) act as negative example pairs.

Furthermore, with reference to data in the storage unit 22 (data set), the generation unit 12 may extract a pair of data which include the same client 30 and server 50 and in which the communication date/time associated with the client 30 and the server 50 is within a preset time period (a positive example pair), and generate sample data by adding a label indicating a positive example to the extracted pair of data.

Note that in the case of a pair of data that include the same server 50 but include different clients 30, the generation unit 12 does not use this pair as sample data. The reason for this is that merely including the same server 50 does not always mean that communication features are similar. This is because, for example, the communication tendency changes depending on a program provided in a client 30. Also, a program provided in a client 30 cannot easily be specified from a proxy log.

Furthermore, in a case where the clients 30 are the same, it is highly likely that a program provided in the client 30 is communicating with a specific server 50. Even in a case where the clients 30 are different, there is a tendency for the communication features to be similar if the same program and server 50 are used.

In addition, if the times are close to each other, there is a low possibility that the configuration of the server 50 changes significantly. For example, regarding a web server and the like, there is a low possibility that the page configuration of the site changes significantly. Therefore, there is a tendency for a pair of data that include close dates/times to have similar communication features.

The learning unit 13 learns a conversion model with use of sample data by way of metric learning. In metric learning, a metric (e.g., a distance or a similarity degree) between pieces of data is learned. For example, a Siamese network, a triplet network, or the like is used in metric learning.

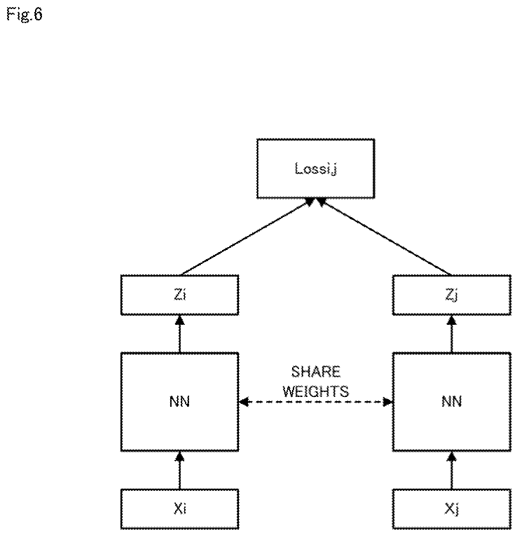

FIG. 6 is a diagram for describing one example of metric learning. In the example of FIG. 6, the conversion model is learned using a loss function that makes use of a distance between low-dimensional vectors after conversion of feature vectors. For example, in the Siamese network, a contrastive loss function is used as the loss function. In the example of FIG. 6, the conversion model is learned so that the distance between a positive example pair is shortened and the distance between a negative example pair is increased.

Note that Xi and Xj of FIG. 6 represent feature vectors of sample data. NN of FIG. 6 represents a neural network that converts feature vectors into low-dimensional vectors. Zi and Zj in FIG. 6 represent low-dimensional vectors. Also, Loss i,j represents a contrastive loss with respect to sample data.

Specifically, first, with use of sample data, the learning unit 13 learns the conversion model that converts feature vectors into low-dimensional vectors. The purpose of conversion of the dimension of feature vectors into a low dimension with use of the conversion model is to perform a search that reflects human senses. That is to say, the purpose is to cause data that is determined to be similar by a worker engaged in security measures to be easily extracted through the search.

The reason why the learning unit 13 lowers the dimension of feature vectors is because, if the search is performed using the distance between feature vectors extracted by the extraction unit 11, there is a high possibility that data that is determined to be similar by a human is not extracted. In view of this, the conversion model that performs conversion into a low dimension is learned using metric learning. In metric learning, the conversion model that performs conversion into a low dimension is learned in consideration of information that is important for a case where a human determines similarity, which enables a search close to human senses.

Subsequently, the learning unit 13 stores information that indicates the structure of the neural network that performed metric learning, as well as information that indicates weights thereof, into the storage unit 23 (conversion model).

The search unit 14 calculates a distance between low-dimensional vectors obtained by converting feature vectors of a search target with use of the conversion model and low-dimensional vectors obtained by converting feature vectors of data with use of the conversion model, and searches for data with the calculated distance equal to or shorter than a preset distance.

A description is now given of a case where there are n pieces of data in the data set (where n is a positive integer).

First, the search unit 14 obtains data that acts as a search target. Subsequently, using the conversion model, the search unit 14 converts the dimension of a feature vector Xq of the data acting as the search target into a low-dimensional vector Zq.

Subsequently, the search unit 14 obtains data from the storage unit 22 (data set). Subsequently, using the conversion model, the search unit 14 converts the dimension of a feature vector X1 of the obtained data into a low-dimensional vector Z1.

Subsequently, the search unit 14 calculates a distance d between the low-dimensional vector Zq and the low-dimensional vector Z1 (Zq, Z1). Here, the distance d (Zq, Zi) is, for example, a Euclidean distance, a cosine distance, or the like. “i” denotes 1 to n.

Subsequently, the search unit 14 determines whether the distanced (Zq, Z1) is equal to or shorter than a preset threshold. In a case where the distance d (Zq, Z1) is equal to or shorter than the threshold, the search unit 14 determines that the feature vector X1 is similar to the feature vector Xq of the data acting as the search target. Note that in a case where the distance d (Zq, Z1) is longer than the threshold, the search unit 14 determines that the feature vector X1 is not similar to the feature vector Xq of the data acting as the search target. Note that the threshold is decided through, for example, an experiment, a simulation, or the like.

Subsequently, the search unit 14 performs the search in the same way with respect to the feature vector Xq of the data acting as the search target and a feature vector X2 of the next data stored in the storage unit 22 (data set). In a case where search processing has been completed with respect to the n pieces of data stored in the storage unit 22, search processing for the data acting as the search target ends.

[Apparatus Operations]

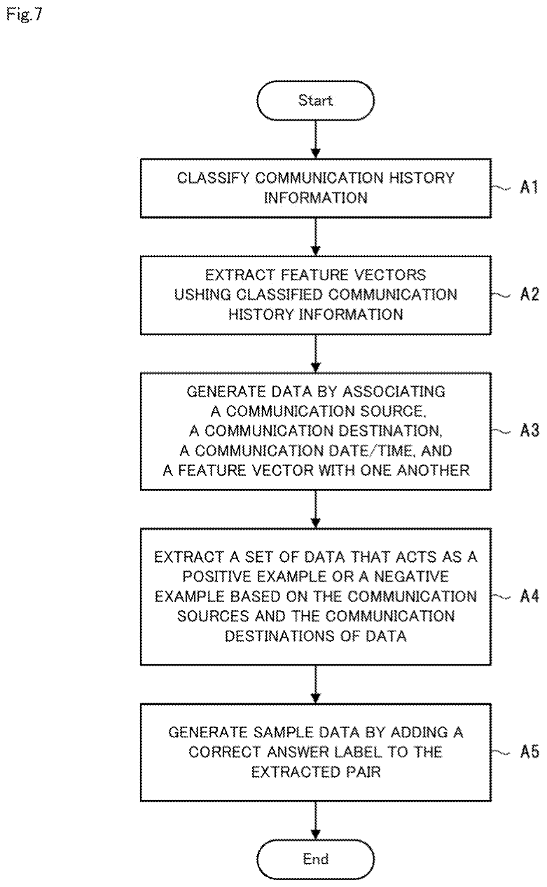

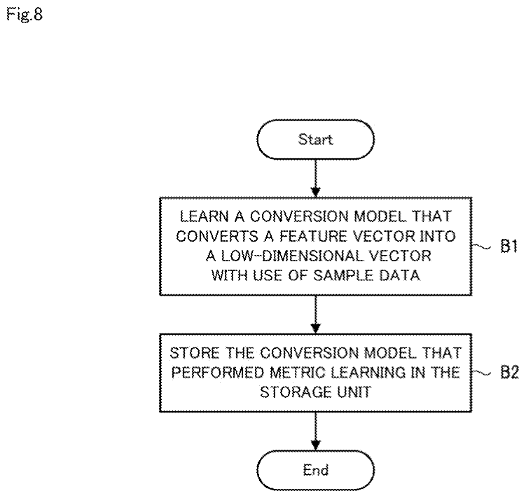

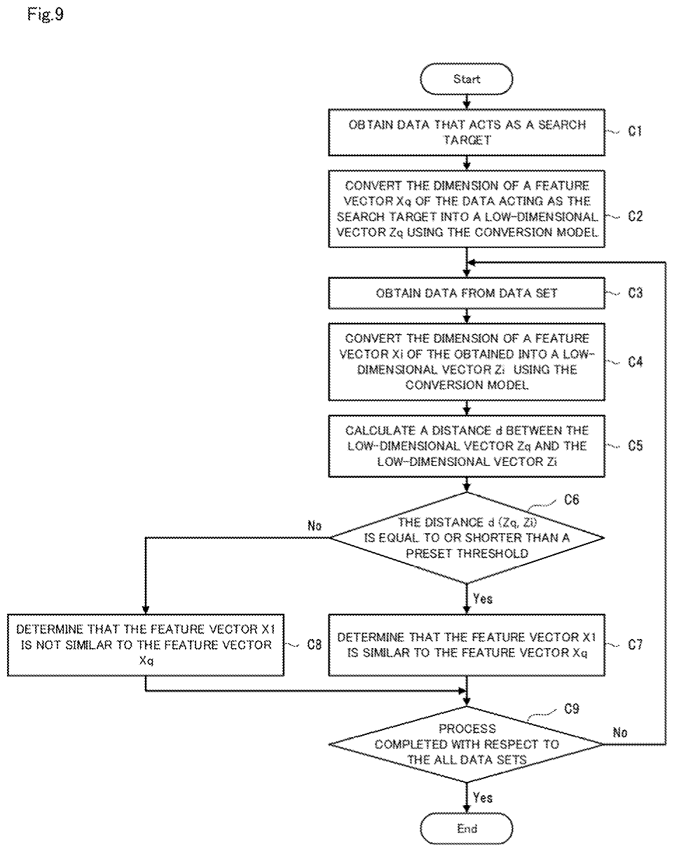

A description is now given of the operations of the information processing apparatus according to the first example embodiment with use of FIG. 7, FIG. 8, and FIG. 9. FIG. 7 is a diagram for describing one example of the operations of the sample data generation apparatus. FIG. 8 is a diagram for describing one example of the operations of the metric learning apparatus. FIG. 9 is a diagram for describing one example of the operations of the search apparatus.

In the following description, FIG. 1 to FIG. 6 will be referred to as appropriate. Also, in the first example embodiment, a sample data generation method, a metric learning method, and a search method are implemented by causing the information processing apparatus to operate. Therefore, the following description of the operations of the information processing apparatus applies to the sample data generation method, the metric learning method, and the search method according to the first example embodiment.

The sample data generation method will be described.

As shown in FIG. 7, first, the extraction unit 11 classifies communication history information pieces based on a communication source, a communication destination, and a communication date/time (step A1). Note that classification of communication history information pieces need not necessarily be performed by the extraction unit 11; a classification unit may be provided separately from the extraction unit 11, and the classification unit may classify communication history information pieces.

Specifically, in step 1, the extraction unit 11 classifies together communication history information pieces that include, for example, the same client 30, server 50, and preset predetermined time period. The predetermined time period means, for example, the same year, month, and date, the same year, month, date, and time frame, or a time period encompassing years, months, or dates that are close to one another.

Subsequently, the extraction unit 11 extracts feature vectors indicating the features of communication with use of the classified communication history information pieces (step A2).

Next, the extraction unit 11 generates data by associating a communication source, a communication destination, a communication date/time, and a feature vector with one another (step A3).

Specifically, in step 3, the extraction unit 11 generates data by associating information that identifies a client 30, information that identifies a server 50, information that indicates a predetermined time period, and the corresponding extracted feature vector with one another, and stores the data into the storage unit 22.

Next, the generation unit 12 extracts a pair of data that acts as a positive example or a negative example based on the communication sources and the communication destinations of data in the storage unit 22 (step A4).

Specifically, in step A1, the generation unit 12 extracts a pair of data that include the same client 30 and server 50 (a positive example pair) with reference to data in the storage unit 22.

Also, in step A1, the generation unit 12 extracts a pair of data that include different clients 30 and servers 50 (a negative example pair) with reference to data in the storage unit 22 (data set).

Furthermore, with reference to data in the storage unit 22 (data set), the generation unit 12 may extract a pair of data which include the same client 30 and server 50 and in which the communication date/time associated with the client 30 and the server 50 is within a preset time period (a positive example pair).

Next, the generation unit 12 generates sample data to be used in metric learning by adding a label indicating a positive example or a negative example to the extracted pair (step A5).

A description is now given of the metric learning method.

As shown in FIG. 8, first, with use of sample data, the learning unit 13 learns a conversion model that converts a feature vector into a low-dimensional vector (step B1).

Next, the learning unit 13 stores information that indicates the structure of a neural network that performed metric learning, as well as information that indicates weights thereof, into the storage unit 23 (conversion model) (step B2).

A description is now given of the search method.

As shown in FIG. 9, first, the search unit 14 obtains data that acts as a search target (step C1). Next, using the conversion model, the search unit 14 converts the dimension of a feature vector Xq of the data acting as the search target into a low-dimensional vector Zq (step C2).

Next, the search unit 14 obtains data from the storage unit 22 (data set) (step C3). Next, using the conversion model, the search unit 14 converts the dimension of a feature vector Xi of the obtained into a low-dimensional vector Zi (step C4).

Next, the search unit 14 calculates a distance d between the low-dimensional vector Zq and the low-dimensional vector Zi (Zq, Zi) (step C5).

Next, the search unit 14 determines whether the distance d (Zq, Zi) is equal to or shorter than a preset threshold (step C6). In a case where the distance d (Zq, Zi) is equal to or shorter than the threshold (Step C6: Yes), the search unit 14 determines that the feature vector X1 is similar to the feature vector Xq of the data acting as the search target (step C7).

Note that in a case where the distance d (Zq, Zi) is larger than the threshold (step C6: No), the search unit 14 determines that the feature vector X1 is not similar to the feature vector Xq of the data acting as the search target (step C8).

Next, in a case where search processing has been completed with respect to the n pieces of data stored in the storage unit 22 (Step C9: Yes), search processing for the data acting as the search target ends. The end of the search processing (Step C9: No) is followed by the step of step C3.

[Effects of First Example Embodiment]

As described above, according to the first example embodiment, sample data used in metric learning can be efficiently generated by using the aforementioned sample data generation apparatus (the apparatus composed of the extraction unit 11 and the generation unit 12). Also, even in a case where the number of sample data used in metric learning is small, tasks of a worker engaged in security measures can be reduced because sample data can be generated automatically.

Furthermore, the use of the aforementioned metric learning apparatus (the apparatus composed of the extraction unit 11, the generation unit 12, and the learning unit 13) enables generation of the conversion model for converting feature vectors into low-dimensional vectors, which has performed metric learning with use of sample data.

That is to say, as the conversion model is a model that has learned in consideration of information that is important for a case where a worker engaged in security measures determines similarity, similar threats can be detected with senses that are close to humans'. The conversion model is a model that has learned without using classification information that is commonly used in metric learning.

Furthermore, by using the aforementioned search apparatus (the apparatus composed of the extraction unit 11, the generation unit 12, the learning unit 13, and the search unit 14), similar threats can be searched for using the features of communication history information pieces without a worker engaged in security measures generating search conditions. Moreover, tasks of a worker engaged in security measures can be reduced also in relation to confirmation of similar threats.

In addition, similar data can be automatically extracted by utilizing the knowledge of domains as if a worker engaged in security measures extracted similar threats (with human senses).

Note that although the first example embodiment has been described while using access logs of a proxy server as examples of communication history information pieces, communication history information pieces used in the invention are not limited to access logs of a proxy server. The application is possible as long as the logs are related to communication between a communication source and a communication destination, and the logs are expected to exhibit certain stationarity when they include the same communication source and communication destination. Specifically, for example, logs of a firewall, flow information of a router, or the like may be used.

[Program]

The program according to the first example embodiment may be a program that causes a computer to execute steps A1 to A5 shown in FIG. 7, steps B1 to B2 shown in FIG. 8, and steps C1 to C7 shown in FIG. 9.

By installing this program in a computer and executing the program, the information processing apparatus (the sample data generation apparatus, the metric learning apparatus, and the search apparatus), the sample data generation method, the metric learning method, and the search method according to the first example embodiment can be realized. In this case, the processor of the computer performs processing to function as the extraction unit 11, the generation unit 12, the learning unit 13, and the search unit 14.

Also, the program according to the first example embodiment may be executed by a computer system constructed by a plurality of computers. In this case, for example, each computer may function as any of the extraction unit 11, the generation unit 12, the learning unit 13, and the search unit 14.

### Second Example Embodiment

The following describes an information processing apparatus according to a second example embodiment. The difference between the first example embodiment and the second example embodiment is that training data that has been generated in advance by a worker engaged in security measures is used in metric learning.

[Apparatus Configuration]

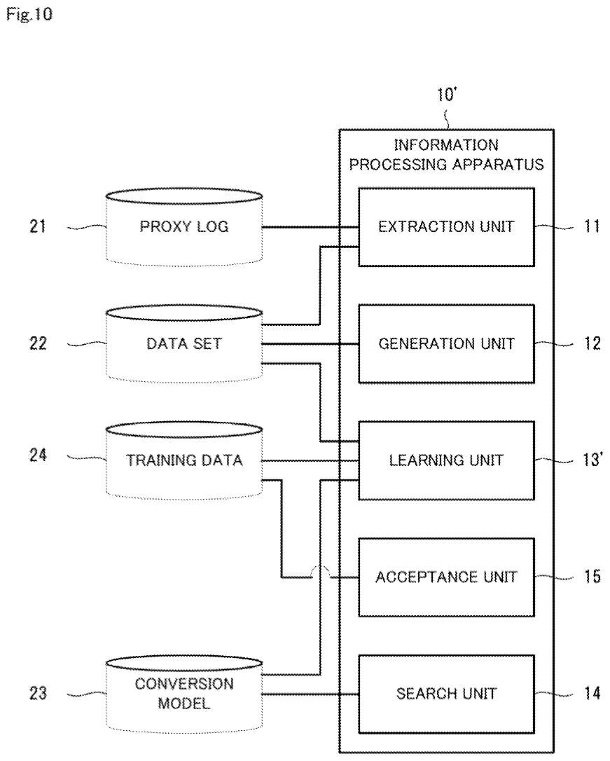

A description is now given of the information processing apparatus according to the second example embodiment with reference to the drawings. FIG. 10 is a diagram for describing one example of the information processing apparatus. An information processing apparatus 10′ shown in FIG. 10 includes an extraction unit 11, a generation unit 12, a learning unit 13′, a search unit 14, and an acceptance unit 15. Also, the information processing apparatus 10′ includes internal or external storage units 21, 22, 23, and 24.

In a case where the information processing apparatus 10 is used as a sample data generation apparatus, a configuration that includes the extraction unit 11 and the generation unit 12 is used. Also, in a case where the information processing apparatus 10 is used as a metric learning apparatus, a configuration that includes the extraction unit 11, the generation unit 12, the learning unit 13′, and the acceptance unit 15 is used. Furthermore, in a case where the information processing apparatus 10 is used as a search apparatus, a configuration that includes the extraction unit 11, the generation unit 12, the learning unit 13′, the search unit 14, and the acceptance unit 15 is used.

A description is now given of the information processing apparatus 10′.

As the extraction unit 11 and the generation unit 12 have already been described in the first example embodiment, a description thereof is omitted.

The acceptance unit 15 accepts training data that has been generated in advance by a worker engaged in security measures. The acceptance unit 15 stores the accepted training data into the storage unit 24 (training data). Providing the acceptance unit 15 makes it possible to manually supply training data, in addition to sample data.

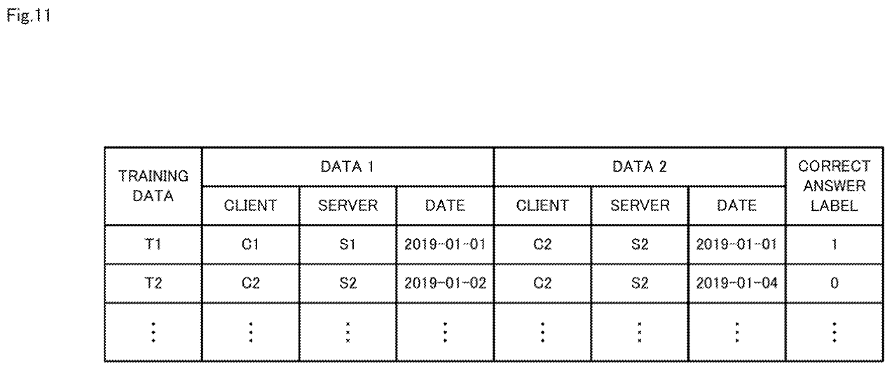

Training data is information in which a pair of data included in a data set stored in the storage unit 23 is associated with a label indicating a positive example or a negative example, and is stored in the storage unit 24. FIG. 11 is a diagram for describing one example of training data. In the example of FIG. 11, it is data in which a pair of data included in the data set is associated with a label. A label is given “1” in the case of a positive example pair, and “0” in the case of a negative example.

The learning unit 13′ performs metric learning with use of sample data generated by the generation unit 12 and training data. In a case where a pair included in the training data is included in the sample data extracted by the generation unit 12, the learning unit 13′ preferentially uses the training data.

Specifically, in a case where a pair of sample data matches a preset pair of training data to which a label indicating a positive example or a negative example has been added, the learning unit 13′ does not use this pair of sample data in learning. That is to say, the label of the training data is used.

In addition, in learning of a conversion model, the weight of training data is set to be larger than that of sample data in a loss function. By increasing the weight of training data in learning, similarity/non-similarity between a pair of training data is easily reflected in a distance after conversion. As a result, the intention of a worker engaged in security measures is reflected.

[Apparatus Operations]

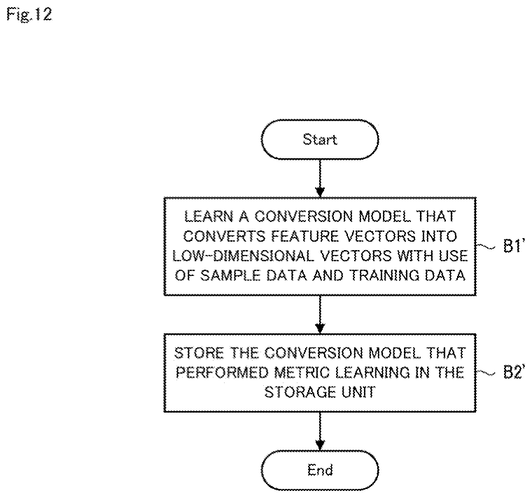

A description is now given of the operations of the information processing apparatus according to the second example embodiment with use of FIG. 12. FIG. 12 is a diagram for describing one example of the operations of the metric learning apparatus.

In the following description, the drawings will be referred to as appropriate. Also, in the second example embodiment, a sample data generation method, a metric learning method, and a search method are implemented by causing the information processing apparatus to operate. As the sample data generation method and the search method have already been described in the first example embodiment, a description thereof is omitted. The following description of the operations of the information processing apparatus applies to the metric learning method according to the second example embodiment.

A description is now given of the metric learning method.

As shown in FIG. 12, first, with use of sample data and training data, the learning unit 13′ learns a conversion model that converts feature vectors into low-dimensional vectors (step B1′).

Next, the learning unit 13′ stores the structure of a neural network that performed metric learning, as well as weights thereof, into the storage unit 23 (conversion model) (step B2′).

### Effects of Second Example Embodiment

As described above, the second example embodiment, in addition to the effect of the first example embodiment, it is possible to reflect the intention of the worker engaged in security measures.

### [Program]

The program according to the second example embodiment may be a program that causes a computer to execute steps A1 to A5 shown in FIG. 7, steps B1′ to B2′ shown in FIG. 12, and steps C1 to C7 shown in FIG. 9.

By installing this program in a computer and executing the program, the information processing apparatus (the sample data generation apparatus, the metric learning apparatus, and the search apparatus), the sample data generation method, the metric learning method, and the search method according to the second example embodiment can be realized. In this case, the processor of the computer performs processing to function as the extraction unit 11, the generation unit 12, the learning unit 13′, the search unit 14, and the acceptance unit 15.

Also, the program according to the second example embodiment may be executed by a computer system constructed by a plurality of computers. In this case, for example, each computer may function as any of the extraction unit 11, the generation unit 12, the learning unit 13′, the search unit 14, and the acceptance unit 15.

[Physical Configuration]

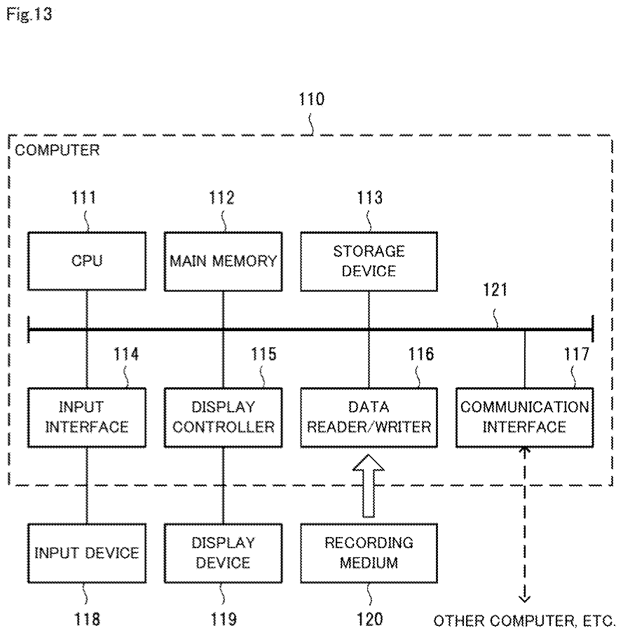

Here, a computer that realizes the information processing apparatus by executing the program according to the first and second example embodiments will be described with reference to FIG. 13. FIG. 13 is a block diagram showing an example of a computer that realizes the information processing apparatus according to first and second example embodiments.

As shown in FIG. 13, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the information processing apparatus according to these first and second example embodiments can also be realized by using hardware corresponding to each unit. Furthermore, a portion of the information processing apparatus 1 may be realized by a program, and the remaining portion realized by hardware.

### [Supplementary Notes]

Furthermore, the following supplementary notes are disclosed regarding the example embodiments described above. Some portion or all of the example embodiments described above can be realized according to (supplementary note 1) to (supplementary note 27) described below, but the below description does not limit the invention.

### (Supplementary Note 1)

A sample data generation apparatus, comprising:

an extraction unit configured to obtain communication history information classified based on a communication source, a communication destination, and a communication date/time; and

a generation unit configured to generate sample data to be used in metric learning by adding a label to data generated by associating the classified communication history information, the communication source, the communication destination, and the communication date/time.

### (Supplementary Note 2)

The sample data generation apparatus according to supplementary note 1, wherein

the extraction unit extracts a feature vector indicating feature of communication with use of the classified communication history information, and generates data by associating the communication source, the communication destination, the communication date/time, and the feature vector, and

the generation unit extracts a pair of data that acts as a positive example or a negative example based on the communication source and the communication destination, and generates sample data to be used in metric learning by adding a label indicating a positive example or a negative example to the extracted pair.

### (Supplementary Note 3)

The sample data generation apparatus according to supplementary note 2, wherein

the generation unit extracts a pair of data that include same the communication source and the communication destination therein, and uses the extracted pair as a positive example.

### (Supplementary Note 4)

The sample data generation apparatus according to supplementary note 2 or 3, wherein

the generation unit extracts a pair of data that include different the communication sources and the communication destinations therein, and uses the extracted pair as a negative example.

### (Supplementary Note 5)

The sample data generation apparatus according to any one of supplementary notes 2 to 4, wherein

the generation unit extracts a pair of data which include same the communication source and the communication destination therein and in which the communication date/time associated with the communication source and the communication destination is within a preset time period, and uses the extracted pair as a positive example.

### (Supplementary Note 6)

A sample data generation method, comprising:

an extraction step of obtaining communication history information classified based on a communication source, a communication destination, and a communication date/time; and

a generation step of generating sample data to be used in metric learning by adding a label to data generated by associating the classified communication history information, the communication source, the communication destination, and the communication date/time.

### (Supplementary Note 7)

The sample data generation method according to supplementary note 6, wherein

in the extraction step, extracting a feature vector indicating feature of communication with use of the classified communication history information, and generating data by associating the communication source, the communication destination, the communication date/time, and the feature vector, and

in the generation step, extracting a pair of data that acts as a positive example or a negative example based on the communication source and the communication destination, and generating sample data to be used in metric learning by adding a label indicating a positive example or a negative example to the extracted pair.

### (Supplementary Note 8)

The sample data generation method according to supplementary note 7, wherein in the generation step, extracting a pair of data that include same the communication source and the communication destination therein, and uses the extracted pair as a positive example.

### (Supplementary Note 9)

The sample data generation method according to supplementary note 7 or 8, wherein

in the generation step, extracting a pair of data that include different the communication sources and the communication destinations therein, and uses the extracted pair as a negative example.

### (Supplementary Note 10)

The sample data generation method according to any one of supplementary notes 7 to 9, wherein

in the generation step, extracting a pair of data which include same the communication source and the communication destination therein and in which the communication date/time associated with the communication source and the communication destination is within a preset time period, and uses the extracted pair as a positive example.

### (Supplementary Note 11)

A computer readable recording medium that includes a program recorded thereon, the program including instructions that cause a computer to carry out:

an extraction step of obtaining communication history information classified based on a communication source, a communication destination, and a communication date/time; and

a generation step of generating sample data to be used in metric learning by adding a label to data generated by associating the classified communication history information, the communication source, the communication destination, and the communication date/time.

### (Supplementary Note 12)

The computer-readable recording medium according to supplementary note 11, wherein

in the extraction step, extracting a feature vector indicating feature of communication with use of the classified communication history information, and generating data by associating the communication source, the communication destination, the communication date/time, and the feature vector, and

in the generation step, extracting a pair of data that acts as a positive example or a negative example based on the communication source and the communication destination, and generating sample data to be used in metric learning by adding a label indicating a positive example or a negative example to the extracted pair.

### (Supplementary Note 13)

The computer-readable recording medium according to supplementary note 12, wherein

in the generation step, extracting a pair of data that include same the communication source and the communication destination therein, and uses the extracted pair as a positive example.

### (Supplementary Note 14)

The computer-readable recording medium according to supplementary note 12 or 13, wherein

in the generation step, extracting a pair of data that include different the communication sources and the communication destinations therein, and uses the extracted pair as a negative example.

### (Supplementary Note 15)

The computer-readable recording medium according to supplementary notes 12 to 14, wherein

in the generation step, extracting a pair of data which include same the communication source and the communication destination therein and in which the communication date/time associated with the communication source and the communication destination is within a preset time period, and uses the extracted pair as a positive example.

### (Supplementary Note 16)

A metric learning apparatus, comprising:

an extraction unit configured to obtain communication history information classified based on a communication source, a communication destination, and a communication date/time;

a generation unit configured to generate sample data to be used in metric learning by adding a label to data generated by associating the classified communication history information, the communication source, the communication destination, and the communication date/time; and

a learning unit configured to learn a conversion model with use of the sample data by way of metric learning.

### (Supplementary Note 17)

The metric learning apparatus according to supplementary note 16, wherein

the extraction unit extracts a feature vector indicating feature of communication with use of the classified communication history information, and generates data by associating the communication source, the communication destination, the communication date/time, and the feature vectors,

the generation unit extracts a pair of data that acts as a positive example or a negative example based on the communication source and the communication destination, and generates sample data to be used in metric learning by adding a label indicating a positive example or a negative example to the extracted pair, and

with use of the sample data, the learning unit learns a conversion model that convers a dimension of feature vector into low-dimensional vector.

### (Supplementary Note 18)

The metric learning apparatus according to supplementary note 17, wherein

in a case where a pair of sample data matches a preset pair of training data to which a label indicating a positive example or a negative example is added, the learning unit does not use the pair of sample data in learning.

### (Supplementary Note 19)

A metric learning method, comprising:

an extraction step of obtaining communication history information classified based on a communication source, a communication destination, and a communication date/time;

a generation step of generating sample data to be used in metric learning by adding a label to data generated by associating the classified communication history information, the communication source, the communication destination, and the communication date/time; and

a learning step of learning a conversion model with use of the sample data by way of metric learning.

### (Supplementary Note 20)

The metric learning method according to supplementary note 19, wherein

in the extraction step, extracting a feature vector indicating feature of communication with use of the classified communication history information, and generating data by associating the communication source, the communication destination, the communication date/time, and the feature vector,

in the generation step, extracting a pair of data that acts as a positive example or a negative example based on the communication source and the communication destination, and generating sample data to be used in metric learning by adding a label indicating a positive example or a negative example to the extracted pair, and

in the learning step, with use of the sample data, learning a conversion model that convers a dimension of feature vector into low-dimensional vector.

### (Supplementary Note 21)

The metric learning method according to supplementary note 20, wherein

in the learning step, in a case where a pair of sample data matches a preset pair of training data to which a label indicating a positive example or a negative example is added, the pair of sample data is not used for learning.

### (Supplementary Note 22)

A computer readable recording medium that includes a program recorded thereon, the program including instructions that cause a computer to carry out:

an extraction step of obtaining communication history information classified based on a communication source, a communication destination, and a communication date/time;

a generation step of generating sample data to be used in metric learning by adding a label to data generated by associating the classified communication history information, the communication source, the communication destination, and the communication date/time; and

a learning step of learning a conversion model with use of the sample data by way of metric learning.

### (Supplementary Note 23)

The computer-readable recording medium according to supplementary note 22, wherein

in the extraction step, extracting a feature vector indicating feature of communication with use of the classified communication history information, and generating data by associating the communication source, the communication destination, the communication date/time, and the feature vectors,

in the generation step, extracting a pair of data that acts as a positive example or a negative example based on the communication source and the communication destination, and generating sample data to be used in metric learning by adding a label indicating a positive example or a negative example to the extracted pair, and

in the learning step, with use of the sample data, learning a conversion model that convers a dimension of feature vector into low-dimensional vector.

### (Supplementary Note 24)

The computer-readable recording medium according to supplementary note 23, wherein in the learning step, in a case where a pair of sample data matches a preset pair of training data to which a label indicating a positive example or a negative example is added, the pair of sample data is not used for learning.

### (Supplementary Note 25)

A search apparatus, comprising:

an extraction unit configured to obtain communication history information classified based on a communication source, a communication destination, and a communication date/time, extract a feature vector indicating feature of communication with use of the classified communication history information, and generating data by associating the communication source, the communication destination, the communication date/time, and the feature vector;

a generation unit configured to extract a pair of data that acts as a positive example or a negative example based on the communication source and the communication destination, and generating sample data to be used in metric learning by adding a label indicating a positive example or a negative example to the extracted pair;

a learning unit configured to learn, with use of the sample data, a conversion model that convers feature vector into low-dimensional vector; and

a search unit configured to calculate a distance between a low-dimensional vector obtained by converting a feature vector of a search target with use of the conversion model and low-dimensional vector obtained by converting feature vector of the data with use of the conversion model, and searching for data with the calculated distance equal to or shorter than a preset distance.

### (Supplementary Note 26)

A search method, comprising:

an extraction step of obtaining communication history information classified based on a communication source, a communication destination, and a communication date/time, extracting a feature vector indicating feature of communication with use of the classified communication history information, and generating data by associating the communication source, the communication destination, the communication date/time, and the corresponding feature vector;

a generation step of extracting a pair of data that acts as a positive example or a negative example based on the communication source and the communication destination therein, and generating sample data to be used in metric learning by adding a label indicating a positive example or a negative example to the extracted pair;

a learning step of learning, with use of the sample data, a conversion model that convers feature vector into low-dimensional vector; and

a search step of calculating a distance between a low-dimensional vector obtained by converting a feature vector of a search target with use of the conversion model and low-dimensional vector obtained by converting feature vector of the data with use of the conversion model, and searching for data with the calculated distance equal to or shorter than a preset distance.

### (Supplementary Note 27)

A computer readable recording medium that includes a program recorded thereon, the program including instructions that cause a computer to carry out:

a step of obtaining communication history information classified based on a communication source, a communication destination, and a communication date/time, extracting a feature vector indicating feature of communication with use of the classified communication history information, and generating data by associating the communication source, the communication destination, the communication date/time, and the corresponding feature vector;

a step of extracting a pair of data that acts as a positive example or a negative example based on the communication source and the communication destination therein, and generating sample data to be used in metric learning by adding a label indicating a positive example or a negative example to the extracted pair;

a step of learning, with use of the sample data, a conversion model that convers feature vector into low-dimensional vector; and

a step of calculating a distance between a low-dimensional vector obtained by converting a feature vector of a search target with use of the conversion model and low-dimensional vector obtained by converting feature vector of the data with use of the conversion model, and searching for data with the calculated distance equal to or shorter than a preset distance.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to efficiently generate sample data to be used in metric learning. The invention is useful in fields where it is necessary to threat hunting.

### REFERENCE SIGNS LIST

1 Sample data generation apparatus
10, 10′ Information processing apparatus
11 Extraction unit
12 Generation unit
13, 13′ Learning unit
14 Search unit
15 Acceptance unit
20 Proxy server
21, 22, 23, 24 Storage unit
30, 30a, 30b, 30c Client
40 Network
50, 50a, 50b, 50c Server
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A sample data generation apparatus, comprising:
an extraction unit configured to obtain communication history information classified based on a communication source, a communication destination, and a communication date/time; and
a generation unit configured to generate sample data to be used in metric learning by adding a label to data generated by associating the classified communication history information, the communication source, the communication destination, and the communication date/time.

2. The sample data generation apparatus according to claim 1, wherein
the extraction unit extracts a feature vector indicating feature of communication with use of the classified communication history information, and generates data by associating the communication source, the communication destination, the communication date/time, and the feature vector, and
the generation unit extracts a pair of data that acts as a positive example or a negative example based on the communication source and the communication destination, and generates sample data to be used in metric learning by adding a label indicating a positive example or a negative example to the extracted pair.

3. The sample data generation apparatus according to claim 2, wherein
the generation unit extracts a pair of data that include same the communication source and the communication destination therein, and uses the extracted pair as a positive example.

4. The sample data generation apparatus according to claim 2, wherein
the generation unit extracts a pair of data that include different the communication sources and the communication destinations therein, and uses the extracted pair as a negative example.

5. The sample data generation apparatus according to claim 2, wherein
the generation unit extracts a pair of data which include same the communication source and the communication destination therein and in which the communication date/time associated with the communication source and the communication destination is within a preset time period, and uses the extracted pair as a positive example.

6. A sample data generation method, comprising:
obtaining communication history information classified based on a communication source, a communication destination, and a communication date/time; and
generating sample data to be used in metric learning by adding a label to data generated by associating the classified communication history information, the communication source, the communication destination, and the communication date/time.

7. A non-transitory computer readable recording medium that includes a program recorded thereon, the program including instructions that cause a computer to carry out:
classifying communication history information based on a communication source, a communication destination, and a communication date/time; and
generating sample data to be used in metric learning by adding a label to data generated by associating the classified communication history information, the communication source, the communication destination, and the communication date/time.

8.-15. (canceled)

16. The sample data generation method according to claim 6, wherein
extracting a feature vector indicating feature of communication with use of the classified communication history information, and generating data by associating the communication source, the communication destination, the communication date/time, and the feature vector, and
extracting a pair of data that acts as a positive example or a negative example based on the communication source and the communication destination, and generating sample data to be used in metric learning by adding a label indicating a positive example or a negative example to the extracted pair.

17. The sample data generation method according to claim 16, wherein
extracting a pair of data that include same the communication source and the communication destination therein, and uses the extracted pair as a positive example.

18. The sample data generation method according to claim 16, wherein
extracting a pair of data that include different the communication sources and the communication destinations therein, and uses the extracted pair as a negative example.

19. The sample data generation method according to claim 16, wherein
extracting a pair of data which include same the communication source and the communication destination therein and in which the communication date/time associated with the communication source and the communication destination is within a preset time period, and uses the extracted pair as a positive example.

20. The non-transitory computer-readable recording medium according to claim 7, wherein
extracting a feature vector indicating feature of communication with use of the classified communication history information, and generating data by associating the communication source, the communication destination, the communication date/time, and the feature vector, and
extracting a pair of data that acts as a positive example or a negative example based on the communication source and the communication destination, and generating sample data to be used in metric learning by adding a label indicating a positive example or a negative example to the extracted pair.

21. The non-transitory computer-readable recording medium according to claim 20, wherein
extracting a pair of data that include same the communication source and the communication destination therein, and uses the extracted pair as a positive example.

22. The non-transitory computer-readable recording medium according to claim 20, wherein
extracting a pair of data that include different the communication sources and the communication destinations therein, and uses the extracted pair as a negative example.

23. The non-transitory computer-readable recording medium according to claim 20, wherein
extracting a pair of data which include same the communication source and the communication destination therein and in which the communication date/time associated with the communication source and the communication destination is within a preset time period, and uses the extracted pair as a positive example.
